(19) United States
(12) Patent Application Publication
(10) Pub. No.: US 2005/0132958 A1
(43) Pub. Date: Jun. 23, 2005

(54) Determination of physical qualities of lubricant

(75) Inventors: Qingfang Leng, Santa Clara County, CA (US); Kasra Khazeni, Santa Clara County, CA (US)

Correspondence Address: STANLEY Z COLE, 26620 ST FRANCIS ROAD, LOS ALTOS HILLS, CA, 94022, US

(73) Assignee: HDI INSTRUMENTATION

(21) Appl. No.: 10/736,613

(22) Filed: Dec. 17, 2003

(51) Int. Cl. G01J 1/42; G03D 5/00; B05C 11/00

(52) U.S. Cl. 118/663; 118/681; 356/225; 396/604

(57) ABSTRACT

A method and apparatus for the mapping, measurement, and determination of the layer of lubrication on the surface of hard magnetic disks. This is achieved through the use of measurements made with optical instrumentation capable of making a number of measurements based on illuminating the hard disk surface with polarized light which is specularly reflected, analyzed, and recorded. An initial measurement is made of the surface layer of lubricant and then the lubricant is removed and another measurement is made of the surface of the disk. The second scan is then subtracted from the first scan to provide a representation of the lubricant layer.

### FIELD OF THE INVENTION

The present invention relates to the measurement of the lubricant layer and its uniformity as present on magnetic recording disks.

### BACKGROUND OF THE INVENTION

Personal computer systems use hard disk drives as the preferred information storage device. To read and write on such drives, a recording head is made to fly above the surface of the disk, while the disk is spinning, and in close proximity thereto. A typical disk has a carbon overcoat sputtered on the surface of magnetic media. To protect the disk surface from contact with the recording head (and the recording head from contact with the disk surface), a fluorinated lubricant such as perfluoropolyether (PFPE) is placed on top of the disk surface. Different techniques for placing a lubricant on the disk may be found, for example, in U.S. Pat. No. 5,232,503 and also in U.S. Pat. No. 6,183,831. Disk tribology and durability are highly dependent on the properties of this lubricant so that the determination of the lubricant thickness, its uniformity and its measurements are extremely important to media manufactures.

### SUMMARY OF THE INVENTION

The present invention is directed to a lubricant measuring system for evaluating the lubricant layer and its uniformity on a finished disk.

For the disk lubrication process it is no longer enough to monitor the lubricant thickness on a single point on the disk surface. Currently most manufacturers of thin film magnetic disk use Fourier Transform Infrared Spectroscopy (FTIR) to monitor lubricant thickness at a single point (or possibly at a few points) on the surface in the manufacturing line.

The lubricant, which for example, may be put on the disk in a dip process or using alternative processes with the result that the lubricant thickness is not uniform across the entire disk surface. For example vibrations in the lubricant tank can result in ripples in the lubricant thickness as to cause a local increase of several Angstroms of lubricant in a line across the disk.

Also the very bottom of the disk could collect a droplet of solvent after it totally clears the solvent/air interface. This solvent droplet evaporates and leaves a lubricant droplet deposit on the chamfer of the disk. Over a period of a few days the lubricant in this droplet can diffuse many millimeters across the disk surface. The free lubricant thickness in this area could be higher by 5 Angstroms or so, which can be as much as 100% more than the intended free lubricant thickness across the disk.

A local increase in free lubricant thickness can result in de-wetting, i.e. lubricant droplet formation. These droplets are high above the surface and the magnetic recording head will interact with these droplets resulting in reliability problems. Thus even though the lubricant thickness on average, as measured with FTIR, is within the manufacturer's specification, there can be local variations in lubricant thickness that result in reliability problems. Therefore it is necessary to monitor not only the lubricant thickness, but also the lubricant uniformity. The present invention describes a way to measure this lubricant uniformity accurately.

The lubricant uniformity mapping system includes the optics with high sensitivity to lubricant thickness and an ability to examine a large field of view, i.e., the entire disk surface. The optics analyzes characteristics such as intensity and polarization of the reflected light. The lubricant uniformity mapping system also includes a programmable dispenser/titrator for pumping a lubricant solvent onto the disk. The lubricant system further includes an automatic shutter system to protect the optics from the contamination of the spun-off solvent from the disk during a de-lubricating process. Although not required for the operation of this system, the lubricant uniformity mapping system may also use a collet chuck for protecting the air bearing spindle used during the de-lubrication step from contamination by the solvent during de-lubricating.

A control and data processing system carries out the de-lubricating process by a spin-rinsing method, and further generates a lubricant uniformity map. Such a map is achieved by making image readings of the disk surface before and after the removal of lubricant on the disk and by subtraction of images one from the other. Image subtraction is straightforward when the procedures described herein are followed. This is because the disk is not physically moved during the de-lube process and the data can be taken at exactly the same position on the disk surface (within the encoder resolution of spindle, which is about a micron). Therefore the image may simply be subtracted by taking the image after the de-lube process from the image before the process. On the other-hand, if this invention is not used then one might have to do an external de-lube step and place the disk back on the spindle after this external step. Yet it will almost be impossible to position the disk back on the spindle within 1 micron of the old location. One can compensate for this position error by moving the after image with respect to the before image before subtracting the data sets, but this will not be as good as subtraction without moving the disk at all.

An object of the present invention is to provide a method and apparatus in which the lubricant uniformity map of a finished disk can be generated automatically.

### BRIEF DESCRIPTION OF THE DRAWINGS

FIG. 1 is a schematic side view showing the present invention of a lubricant uniformity mapping system; FIG. 1A is a schematic side view showing the test stand and the control electronics;

FIG. 2 is a flow chart of a process of generating lubricant uniformity map;

FIG. 3 is a schematic side view showing a bottle-top syringe style dispenser/titrator in accordance with a first embodiment of the programmable dispenser/titrator of the present invention;

FIG. 4 is a schematic side view showing a peristaltic pump style dispenser/titrator in accordance with a second embodiment of the programmable dispenser/titrator of the present invention;

FIG. 5 is a schematic side view showing a air driven style dispenser/titrator in accordance with a third embodiment of the programmable dispenser/titrator of the present invention;

FIG. 6 is a schematic side view showing a rotary shutter system in accordance with a first embodiment of the automatic shutter system of the present invention; and

FIG. 7 is a schematic side view showing a linear shutter system in accordance with a second embodiment of the automatic shutter system of the present invention.

Various other features and advantages of the present invention will be more fully understood by reference to the following detailed description in conjunction with the attached drawings.

### DETAILED DESCRIPTION

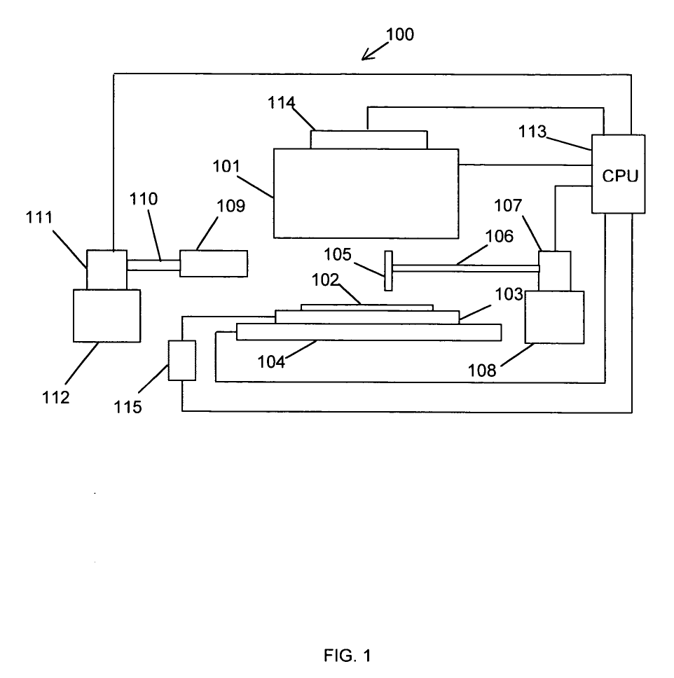

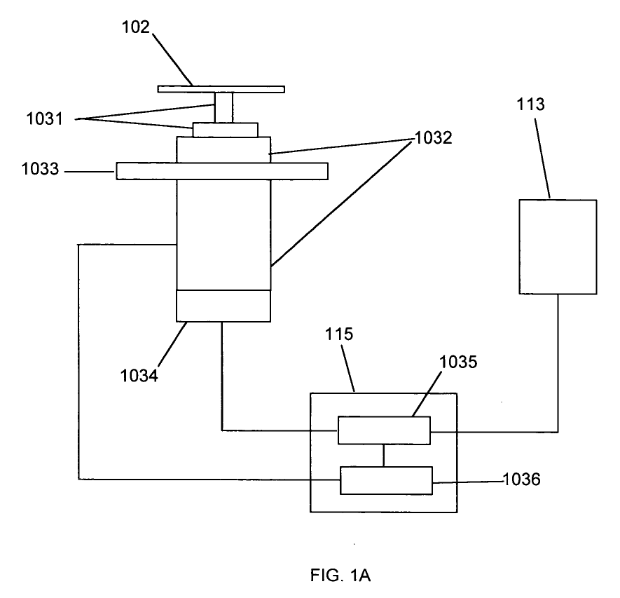

A lubricant uniformity mapping system 100 for evaluating the uniformity of deposited lubricant on a finished magnetic recording disk 102 in accordance with the present invention is shown in FIG. 1. The film optics 101 including an illumination system for producing a polarized light beam and a detection system for measuring the intensity of the polarized light reflected from the disk 102 is described in U.S. Pat. No. 6,307,627, the disclosure of which is hereby incorporated by this reference. The film optics and the corresponding electronics as described in U.S. Pat. No. 6,307,627, provide the capability of analyzing the reflected light from disk 102 with 8 channels: P-polar, S-polar, Phase Contrast, Enhanced Phase Contrast, Scattered, Differential Phase Contrast, Circumferential, and Radial and the instrumentation of said patent is incorporated herein as the optics 101.

The disk 102 to be tested is supported by a test stand or base 103 and the film optics 101 is movably suspended on a track or stage 114 for one-dimensional translational movement along an axis perpendicular to the plane of the paper as shown in FIG. 1 over the X-Y table or base 104. Alternatively, the X-Y table or base 104 can move the disk 102 which is mounted on a test stand or base 103 relative to the optics while the optics is held stationary. The control electronics 115 rotates the disk 102 at a speed of 100-30,000 RPM or to control the angular position of the disk 102 to an accuracy of about 0.2 degrees and preferably less than about 0.1 degrees through the test stand or base 103.

Furthermore, as shown in FIG. 1A, the test stand or base 103 includes a chuck 1031, a spindle 1032, a rotary encoder 1034, and a spindle mounting plate 1033. The disk 102 is mounted on the chuck 1031 that is fixed on the spindle 1032. The control electronics 115 comprising a motion control card 1035 and a motor power amplifier 1036 is commanded by a PC 113 to perform the speed and position control of the spindle.

When the disk 102 is rotating it will not be necessary to control the angular position to less than 0.2 degrees. However it will be necessary to measure the exact rotational position of the disk to better than 0.2 degrees using the rotary encoder 1034. This rotary encoder information is read by the motion control card 1035 and will be used to generate the coordinates for the location of data in the surface map. If insufficient resolution is used, the maps taken before and after de-lubing can be of data taken at different positions on the disk. When the images are subtracted from one another, the locations do not match exactly and the subtraction would be noisy.

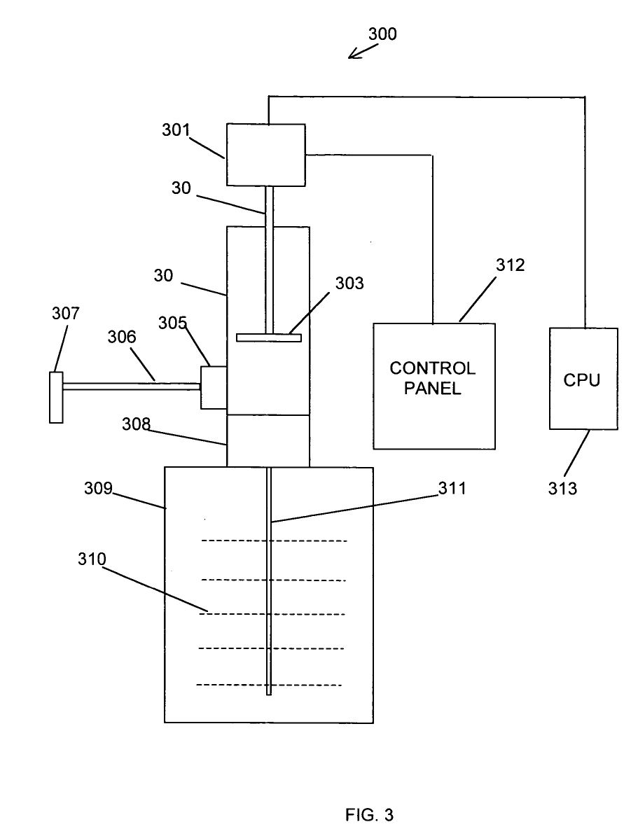

A programmable dispenser/titrator 107 pumps the lubricant solvent stored in a bottle 108 onto a disk 102 through a tubing 106 and a nozzle 105. The lubricant solvent may comprise HFE-7100 available from 3M corporation or other solvents from alternative sources. The tubing 106 is, for example, PTFE tubing or may comprise other like tubing material. The dispenser/titrator will be discussed more completely in connection with FIGS. 3, 4 and 5.

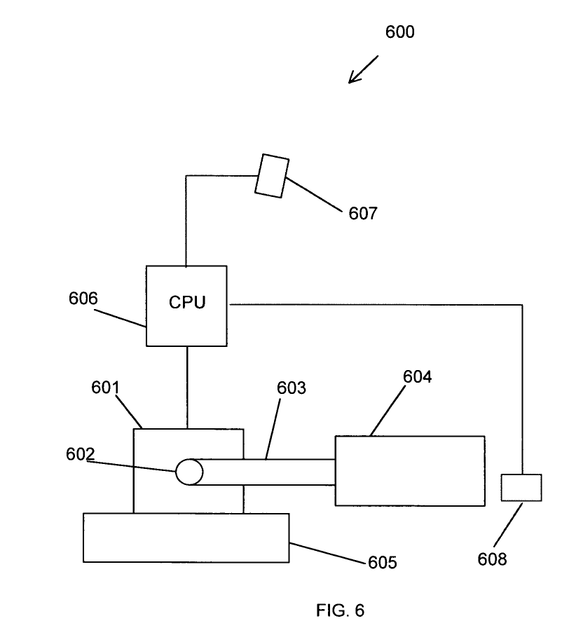

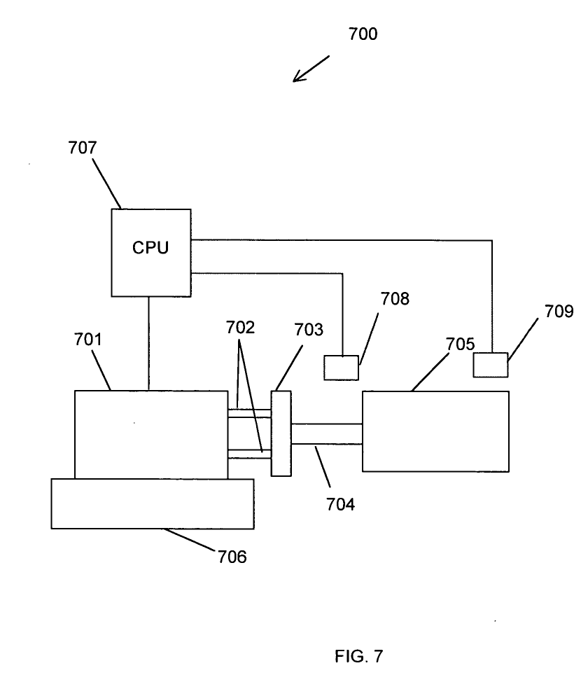

An automatic shutter system comprising shutter 109, arm 110, actuator 111 and support base 112 is also shown in FIG. 1. The automatic shutter system provides the protection of the optics from the contamination of the spun-off solvent from the disk 102 during the de-lubricating process described hereinafter. The shutter system will be discussed in some further detail in connection with FIGS. 6 and 7.

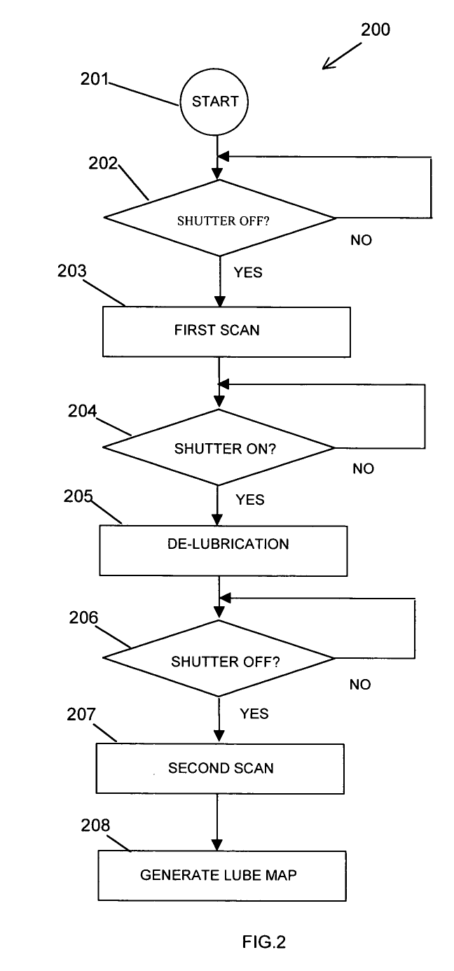

A personal computer or CPU 113 commands the motion control and data processing of the film optics 101, the dispenser/titrator 107, the shutter activators 11, the test stand 103 through the control electronics 115, and the stage 114 or the X-Y table 104 to generate the lubricant uniformity map of a disk 102 by the following procedure described in connection with FIG. 2.

In FIG. 2, the process steps of generating a lubricant uniformity map from a finished disk is shown as a flow chart 200. Program flow starts at 201. This shows the order of events in which open/close shutter, optical scans, and rinse actions occur. First, the shutter position is checked at 202 to detect whether the film optics is in an operating position to scan the disk. If the shutter is positioned between the optics and the disk (NO), then the shutter position is checked again. If the shutter is off (YES), i.e. the shutter is removed from the position, between the optics and the disk, then the program flow proceeds to First Scan 203 in which images of Phase Contrast, Enhanced Phase and/or Differential Phase Contrast channels are taken of the regions of interest on the disk surface. The signal in these images is sensitive to many different properties of the disk, such as lubricant thickness, carbon thickness, surface texture, surface defects etc. The data acquisition is triggered by the encoder index signal of the test stand 103 (FIG. 1). A linear encoder on the translation stage and a rotary encoder on the spindle provide position information of each of the individual locations where the optical reflectivity is measured. The rotary encoder on the spindle is a dual 1024 linear encoder and in quadrature mode supplies 4096 pulses per revolution. Further more, special phase lock loop electronics are used that allow one to interpolate between the hardware encoder pulses up to 512×1024 pulses per revolution. The linear encoder is accurate to within 0.1 micron or better. Thus at any point in time one can determine to within 1 micron or better where the data is taken from on the disk surface.

After completion of step 203, the shutter position is checked again at 204 to detect whether the optics is protected by the shutter. If the shutter is off (NO), i.e. the shutter is not positioned between the optics and the disk, then the shutter position is checked again. If the shutter is on (YES) then the de-lubricating process of 205 is performed. In step 205, a spin-rinsing method is used. For example, a lubricant solvent, such as HFE-7100, is streamed onto the spinning disk 102 by the dispenser/titrator 107 from the inner diameter (ID) to the outer diameter (OD) or from OD to ID to remove the non-bonded lubricant from disk 102. A multiple de-lubricating process between ID and OD may be needed to fully remove the free lubricant on the disk. Part of the lubricant may be bonded to the disk surface and will in such a case not be removed by this process.

After completion of de-lubrication, the shutter position is again checked to detect whether the optics is clear for scanning the disk. If the shutter is positioned between the film optics and the disk (NO), then the shutter position is checked again. If the shutter is off (YES), i.e. the shutter is removed from the position between the optics and the disk, then the program flow proceeds to Second Scan 207 in which the images of Phase Contrast Enhanced Phase Contrast and/or Differential Phase Contrast channels are taken again. The data acquisition is triggered by an encoder index signal of the test stand 103. The second set of images again contain a variety of information about the disk surface, such as lubricant thickness, carbon thickness, surface texture and surface defects.

After completion of the step illustrated at box 207, a lube map is generated at stage 208. At box 208, a lubricant map is generated by subtracting, the second set of images (after the rinse procedure) from the first set of images (before the rinse procedure). The encoders on the spindle and linear stage ensure that each of the pixels of the separate image sets are taken at the same location on the disk. Therefore the images that result from the subtraction only contain the difference information due to the rinse procedure. For example, since the carbon film is not removed by this rinse procedure, the effects from carbon thickness variations are present in both images (before and after rinse). Thus the resulting subtraction removes the signal from the carbon thickness.

The resultant difference images are only sensitive to the material that was removed by the solvent, namely the non-bonded or free lubricant. The difference images are the result of a subtraction of reflected light intensity, e.g. Phase Contrast, Enhanced Phase Contrast or Differential Phase Contrast data. The measured change in light intensity can be converted to film thickness, using a calibration table. Converting the above different images into lubricant thickness map using a calibration table then generated the lubricant uniformity map. Typically there is a linear relationship between the change in reflected light intensity and the removed lubricant thickness. Depending on the material, substrate and optical channel used for the scanning the sensitivity varies from 1 to 100 Angstrom/percent reflectivity.

An embodiment of a dispenser/titrator 300 is shown in FIG. 3. It is a bottle-top syringe style dispenser/titrator, such as model AKKU-DRIVE 9568200 available from Hirschmann, Inc. A dispensing piston 303 driven by a motor 301 though a shaft 302 pumps the solvent 310 from the bottle 309 into the reservoir 304 through a suction valve 308 and a inlet tubing 311. The solvent is then dispensed by a nozzle 307 through a discharge valve 305 and tubing 306. The dispensing volume and flow rate are controlled by either a control panel 312 (manually) or a computer (PC or CPU) 313 through serial communication (RS-232) port, present on both the titrator and the computer.

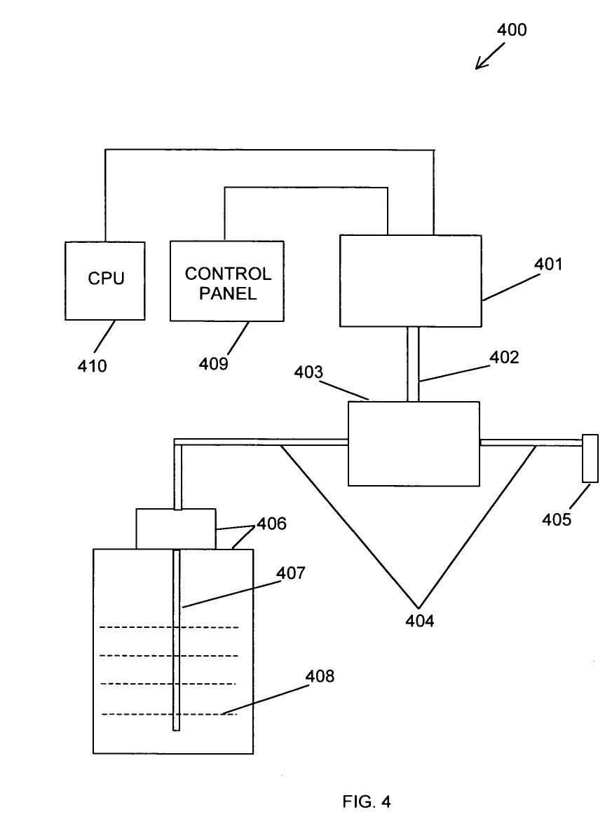

A second embodiment of the dispenser/titrator 400 is shown in FIG. 4. It is a peristaltic pump style dispenser/titrator. A peristaltic pump head 403 driven by a motor 401 though an interface 402 pumps the solvent 408 from the bottle 406 to a nozzle 405 through both inlet and outlet tubings 404. The dispensing volume and flow rate are controlled by either a control panel 409 manually or a PC or CPU 410 through an RS-232 serial port.

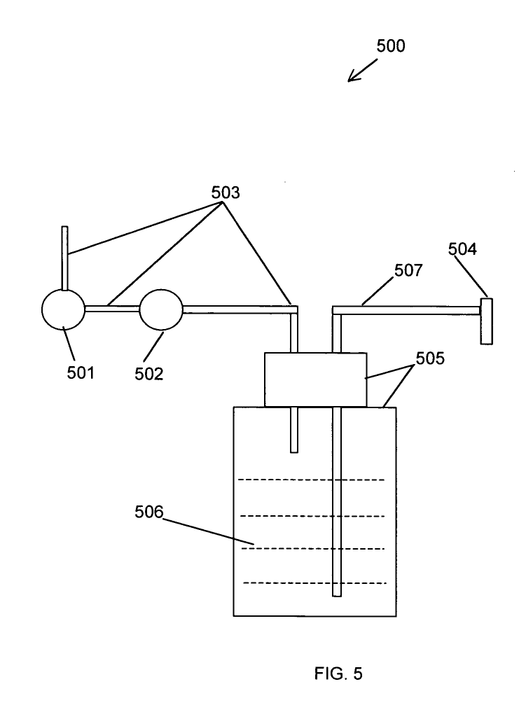

A third embodiment of the dispenser/titrator 500 is shown in FIG. 5. It is an air driven style dispenser/titrator. When the pure air is blown into the sealed bottle 505 through an inlet tubing 503, the solvent 506 is pushed out of the bottle 505 to the nozzle 504 through the outlet tubing 507. The dispensing flow rate is set by the air regulator 501, and the dispensing volume is controlled by the electronic valve 502.

A first embodiment of the automatic shutter system 600 is shown in FIG. 6. It is a rotary shutter system. The shutter 604 supported by an arm 603 is driven by a rotary actuator 601, like a SMC Pneumatics, Inc's MDSUB1-90S-90, through a shaft 602. The rotary actuator 601 could be a pneumatic turntable or a motor, such as a stepper motor, a servomotor, an ultrasonic motor, or a piezoelectric motor. The actuator 601 is mounted on a base 605. A PC or CPU 606 controls the actuator 601 to rotate the shutter 604 up and down about 90 degree along the shaft 602. The position of the shutter is determined by built-in position sensors mounted on the shaft 602 that detect the angular position of the shaft at some pre-set positions, like 0 degree or 90 degrees to the horizontal direction, or a built-in rotary encoder mounted on the shaft 602 that measures the angular position of the shaft. The position of the shutter also can be determined by separate position sensors 607 and 608. These position sensors can be optical or magnetic limit switches mounted near the two ends of the shutter travel range. When the shutter 604 is on, it is rotated down, pointed to the horizontal direction, and then positioned between the optics and the disk for protecting the optics from the spun-off solvent during the de-lubricating process. When the shutter 604 is off, it is rotated up 90 degrees from the horizontal direction, and then moved away from the position between the optics and the disk to clear the space for scanning the disk.

A second embodiment of the automatic shutter system 700 is shown in FIG. 7. It is a linear shutter system. The shutter 705 supported by an arm 704 and a bracket 703 is driven by a linear actuator 701, like a SMC Pneumatics, Inc's CXSM6100Z762, through rods 702. The linear actuator 701 could be a pneumatic cylinder or a motorized stage using a stepper motor, or a servomotor, or an ultrasonic motor, or a piezoelectric motor.

The linear actuator 701 is mounted on a base 706. A PC or CPU 707 controls the linear actuator 701 to move the shutter 705 in and out along the horizontal direction. The position of the shutter is determined by a linear encoder built-in the actuator 701 that measures the position of rods 702 at some pre-set positions, or built-in position sensors that detect the position of the rods 702 at some pre-set positions, such as the in and out positions along the horizontal direction. The position of the shutter can also be determined by two separate position sensors 708 and 709. These position sensors can be optical or magnetic limit switches mounted near the two ends of the shutter travel range. When the shutter 705 is on, it is moved to the position between the optics and the disk for protecting the optics from the spun-off solvent during the de-lubricating process. When the shutter 705 is off, it is retrieved back from the position between the optics and the disk to clear the space for scanning the disk.

While there has been shown and described what are presently considered the preferred embodiments, it will be obvious to those skilled in the art that various changes and modifications may be made without departing from the scope of this invention and the coverage of the appended claims.

1. A lubricant mapping system for evaluating the uniformity of deposited lubricant on a finished magnetic disk comprising
film optics including an illumination system for producing a polarized light beam and a detection system for measuring the intensity of polarized light reflected from a disk under test as to provide the capability to analyze various characteristics of reflected light from the disk;
a test stand including a rotatable spindle to rotate and support a disk under test;
means to bring about relative movement between a disk on said test stand and said film optics;
means to rotate the disk on said spindle at a selected speed of more than 100 RPM and to measure the angular position of the disk at an angular position accuracy about 0.2 degrees or less:
an automatic shutter system to protect said film optics from contamination of solvent during a lubrication treatment of the disk;
a programmable dispenser/titrator to pump lubricant onto a disk; and,
a computer to interrelate the spinning of the disk and the treatment and data processing of the disk surface in a determination of map of and the qualities of the lubricant layer on the surface of the disk.

2. The process of generating a lubricant uniformity map of the lubrication layer of a hard magnetic disk comprising:
spinning a hard disk in relation to an optical instrument capable of measuring reflected light from polarized light fed to the surface of said spinning disk;
making a first scan of the disk surface;
protect the optical instrument from lubricant materials on the surface of the disk through the use of a shutter mechanism;
performing a de-lubrication process by spin-rinsing the disk by feeding a lubricant solvent onto the surface of a spinning disk to remove the non-bonded lubricant from the surface of the disk;
determining that the optical instrument is ready for scanning by opening the shutter mechanism;
making a second scan of the disk surface with the optical instrumentation; and,
generate a map of the lubricant layer on the surface of disk by subtracting said first scan from said second scan made with the optical instrumentation.

3. The system of claim 1 in which the shutter system is a linear shutter system.

4. The shutter system of claim 1 in which the shutter system is a rotary shutter system.

5. The system of claim 1 in which the dispenser/titrator is a bottle-top syringe style dispenser/titrator.

6. The system of claim 1 in which the dispenser/titrator is a peristaltic pump style dispenser/titrator.

7. The system of claim 1 in which the dispenser/titrator is an air driven programmable dispenser/titrator.

8. The lubricant mapping system of claim 1 including a collet chuck for protecting the spindle from contamination by the solvent.

9. The process of claim 2 in which the lube is spin coated onto the disk.

10. The system of claim 1 in which the disk is caused to rotate at a speed of up to 30,000 RPM.

11. The system of claim 1 in which the angular position measurement accuracy is about 0.1 degree.

12. The system of claim 1 in which said film optics determines at least two measurements from the group consisting of Phase Contrast, Enhanced Phase Contrast and/or Differential Phase Contact data

13. A lubricant mapping system for evaluating the uniformity of deposited lubricant on a finished magnetic disk comprising
film optics including an illumination system for producing a polarized light beam and a detection system for measuring the intensity of polarized light reflected from a disk under test as to provide the capability to analyze various characteristics of reflected light from the disk;
a test stand including a rotatable spindle to rotate and support a disk under test;
means to bring about relative movement between a disk on said test stand and said film optics;
means to rotate the disk on said spindle at a selected speed of between 100 to 30,000 RPM and to control the angular position of the disk at an angular position accuracy of less than about 0.2 degrees:
an automatic shutter system to protect said film optics from contamination of solvent during a lubrication treatment of the disk;
a programmable dispenser/titrator to pump lubricant onto a disk; and,
a computer to interrelate the spinning of the disk and the treatment and data processing of the disk surface in a determination of map of and the qualities of the lubricant layer on the surface of the disk.

14. The system of claim 13 in which a first scan is made with lubricant on the disk and a second scan is made following flushing of the lubricant from the disk.

15. The system of claim 14 in which the second scan is subtracted from the first scan as to generate a map of the lubricant layer.
